(19) United States
(12) Patent Application Publication
(10) Pub. No.: US 2021/0065992 A1
(43) Pub. Date: Mar. 4, 2021

(54) ELECTROCHEMICAL CELLS INCLUDING SULFUR-CONTAINING CAPACITORS

(71) Applicant: GM GLOBAL TECHNOLOGY OPERATIONS LLC, Detroit, MI (US)

(72) Inventors: Yong LU, Shanghai (CN); Zhe LI, Shanghai (CN)

(73) Assignee: GM GLOBAL TECHNOLOGY OPERATIONS LLC, Detroit, MI (US)

(21) Appl. No.: 16/661,364

(22) Filed: Oct. 23, 2019

(30) Foreign Application Priority Data
Sep. 4, 2019 (CN) 201910851444.9

(51) Int. Cl. H01G 11/06; H01G 11/28; H01G 11/34; H01G 11/46; H01M 4/40; H01M 4/505; H01M 4/485; H01M 4/587; H01M 10/0525

(52) U.S. Cl. CPC H01G 11/06; H01G 11/28; H01G 11/34; H01G 11/46; H01M 2004/027; H01M 4/505; H01M 4/485; H01M 4/587; H01M 10/0525; H01M 4/405

(57) ABSTRACT

A capacitor-assisted electrochemical cell according to various aspects of the present disclosure includes at least two first electrodes including one or more positive electroactive material layers disposed in electrical communication with a positive current collector; at least one second electrode including one or more first negative electroactive material layers disposed in electrical communication with a first negative current collector; and at least one composite electrode including one or more second negative electroactive material layers disposed in electrical communication with a second negative current collector. The second negative electroactive material layers may be in the form of a plurality of negative electroactive particles including one or more of a carbonaceous material and a metal oxide. Each negative electroactive particle may have a plurality of pores and a plurality of sulfur-additive particles disposed within the plurality of pores.

### CROSS-REFERENCE TO RELATED APPLICATIONS

This application claims the benefit and priority of Chinese Patent Application No. 201910851444.9, filed Sep. 4, 2019. The entire disclosure of the above application is incorporated herein by reference.

### INTRODUCTION

This section provides background information related to the present disclosure which is not necessarily prior art.

The present disclosure relates to electrochemical cells including sulfur-containing capacitors and hybrid supercapacitor-battery systems (e.g., lithium-ion capacitors).

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”). For example, capacitors can provide high power density (e.g., about 10 kW/kg) in power-based applications and lithium-ion batteries can deliver high energy densities (e.g., about 100 Wh/kg-300 Wh/kg). In various instances, capacitor-assisted batteries (“CABs”) (e.g., a lithium-ion capacitor hybridized with a lithium-ion battery in a single cell core) may provide several advantages, such as enhanced power capability compared with lithium-ion batteries. For example, integrated capacitors or super capacitors may be used to supply current during engine startup so as to limit current draw from the lithium-ion battery during start-up. In certain instances, capacitor-assisted systems may experience comparatively low energy densities. For example, such energy densities may result from increased electrolyte requirements, which may be a product of the comparatively large surface area of the anode-capacitor material and its lower capacity and need for increased quantities of an electrolyte. Accordingly, it would be desirable to develop capacitor-assisted batteries or hybrid devices and systems having both enhanced power capabilities and increased energy densities.

### SUMMARY

This section provides a general summary of the disclosure, and is not a comprehensive disclosure of its full scope or all of its features.

In various aspects, the present disclosure provides a capacitor-assisted electrochemical cell. The capacitor-assisted electrochemical cell may include at least two first electrodes including one or more positive electroactive material layers disposed in electrical communication with a positive current collector; at least one second electrode including one or more first negative electroactive material layers disposed in electrical communication with a first negative current collector; and at least one composite electrode including one or more second negative electroactive material layers disposed in electrical communication with a second negative current collector. The second negative electroactive material layers may be in the form of a plurality of negative electroactive particles including one or more of a carbonaceous material and a metal oxide. Each negative electroactive particle may have a plurality of pores and a plurality of sulfur-additive particles disposed within the plurality of pores.

In various aspects, the negative electroactive particles may have an average particle size greater than or equal to about 1 nm to less than or equal to about 1000 μm and a porosity greater than or equal to about 5 vol. % to less than or equal to about 80 vol. %.

In various aspects, the sulfur-additive particles may occupy greater than or equal to about 0.01 vol. % to less than or equal to about 100 vol. % of a total pore volume of each negative electroactive particle.

In various aspects, the pores may have an average diameter greater than or equal to about 0.1 nm to less than or equal to about 500 nm and the sulfur-additive particles may have an average particle size greater than or equal to about 0.1 nm to less than or equal to about 500 nm.

In various aspects, the at least one composite electrode may have a thickness greater than or equal to about 1 μm to less than or equal to about 500 μm.

In various aspects, the at least one composite electrode may further include one or more additional negative electroactive materials selected from the group consisting of: lithium metal, lithium alloy, silicon (Si), silicon alloy, silicon oxide activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In various aspects, the one or more additional negative electroactive materials may be provided in one or more third negative electroactive material layers.

In various aspects, the one or more third negative electroactive material layers maybe be one of disposed between the one or more second negative electroactive material layers and the second negative current collector and disposed on one or more exposed surfaces of the of the one or more second negative electroactive material layers when the one or more second negative electroactive material layers are disposed on the one or more exposed surfaces of the second negative current collector.

In various aspects, the at least one composite electrode may further include one or more third negative electroactive material layers. The one or more third negative electroactive material layers may include one or more negative electroactive materials selected from the group consisting of: lithium metal, lithium alloy, silicon (Si), silicon alloy, silicon oxide activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof. The one or more third negative electroactive material layers may be one of disposed between the one or more second negative electroactive material layers and the second negative current collector and disposed on one or more exposed surfaces of the of the one or more second negative electroactive material layers when the one or more second negative electroactive material layers are disposed on the one or more exposed surfaces of the second negative current collector.

In various aspects, the carbonaceous material may be selected from the group consisting of: activated carbon (AC), hard carbon (HC), soft carbon (SC), graphite, and combinations thereof and the metal oxide may be selected from the group consisting of: titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂), and combinations thereof.

In various aspects, the one or more positive electroactive material layers may include a positive electroactive material selected from the group consisting of: LiCoO₂ (LCO), LiNiₓMn_{y}Co_{1-x-y}O₂ (where 0≤x≤1 and 0≤y≤1), LiNi_{1-x-y}CoₓAl_{y}O₂ (where 0≤x≤1 and 0≤y≤1), LiNiₓMn₁₋ₓO₂ (where 0≤x≤1), Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), and combinations thereof. The one or more first negative electroactive material layers may include a first negative electroactive material selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In various aspects, each of the one or more first electrodes, the one or more second electrodes, and the at least one composite electrode may further include greater than or equal to about 0 wt. % to less than or equal to about 30 wt. % of one or more conductive additives selected from the group consisting of: carbon black, graphite, graphene, graphene oxide, acetylene black, carbon nanofibers, carbon nanotubes, and combinations thereof; and greater than or equal to about 0 wt. % to less than or equal to about 20 wt. % of one or more binders selected from the group consisting of: poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof.

In various aspects, the capacitor-assisted electrochemical cell may further include greater than or equal to about 1 wt. % to less than or equal to about 20 wt. % of an electrolyte. The electrolyte may be disposed between the at least two first electrodes, the at least one second electrode, and the at least one composite electrode. A portion of the electrolyte may also be disposed within the plurality of pores in each negative electroactive particle in the at least one composite electrode.

In various other aspects, the present disclosure provides a capacitor-assisted electrochemical cell including a positive electrode including a positive electroactive material layer, and a composite electrode including a negative electroactive material layer. The negative electroactive material layer may include a plurality of first negative electroactive particles and a plurality of second negative electroactive particles. Each of the second negative electroactive particles of the plurality of second negative electroactive particles includes one or more of a carbonaceous material and a metal oxide. Each second negative electroactive particle of the plurality of second negative electroactive particles has a plurality of pores and a plurality of sulfur-additive particles embedded within the plurality of pores.

In various aspects, the negative electroactive material layer may be a first negative electroactive material layer and the capacitor-assisted electrochemical cell may further include a negative electrode including a second negative electroactive material layer. The second negative electroactive material layer may include one or more negative electroactive materials selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In various aspects, the second negative electroactive particles may have an average particle size greater than or equal to about 1 nm to less than or equal to about 1000 μm and a porosity greater than or equal to about 5 vol. % to less than or equal to about 80 vol. %, and the sulfur-additive particles may occupy greater than or equal to about 0.1 vol. % to less than or equal to about 100 vol. % of a total pore volume of each second negative electroactive particle.

In various aspects, the pores may have an average diameter of greater than or equal to about 0.1 nm to less than or equal to about 100 nm and the sulfur-additive particles may have an average particle size of greater than or equal to about 0.1 nm to less than or equal to about 100 nm.

In various aspects, the composite electrode may include greater than or equal to about 0.01 wt. % to less than or equal to about 99.99 wt. % of the first negative electroactive particles and greater than or equal to about 0.01 wt. % to less than or equal to about 99.99 wt. % of the second negative electroactive particles. The composite electrode may further include greater than or equal to about 1 wt. % to less than or equal to about 20 wt. % of an electrolyte.

In various aspects, the first negative electroactive particles may include one or more first negative electroactive materials selected from the group consisting of: activated carbon (AC), hard carbon (HC), soft carbon (SC), silicon (Si), silicon oxide, tin (Sn), titanium dioxide (TiO₂), ferrous sulfide (FeS), lithium titanium oxide (LiTi₅O₁₂) (LTO), titanium niobium oxide (TiₓNb_{y}O_{z} where 0≤x≤2, 0≤y≤24, and 0≤z≤64), and combinations thereof. The second negative electroactive particles may include one or more second negative electroactive materials selected from the group consisting of: activated carbon (AC), hard carbon (HC), soft carbon (SC), titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂), and combinations thereof.

In various other aspects, the present disclosure provides an electroactive material that forms a portion of a capacitor. The electroactive material may include a plurality of negative electroactive particles including one or more of a carbonaceous material and a metal oxide. The negative electroactive particles may each have a plurality of pores. A plurality of sulfur-additive particles may be disposed within the plurality of pores of the negative electroactive particles. The carbonaceous material may be selected from the group consisting of: activated carbon (AC), hard carbon (HC), soft carbon (SC), and combinations thereof. The metal oxide may be selected from the group consisting of: titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂), and combinations thereof.

In various aspects, the negative electroactive particles may have an average particle size greater than or equal to about 1 nm to less than or equal to about 1000 μm and a porosity greater than or equal to about 5 vol. % to less than or equal to about 80 vol. %; and the sulfur-additive particles may occupy greater than or equal to about 0.01 vol. % to less than or equal to about 99.99 vol. % of a total pore volume of each negative electroactive particle.

In various aspects, the plurality of pores may have an average diameter greater than or equal to about 0.1 nm to less than or equal to about 100 nm and the sulfur-additive particles may have an average particle size greater than or equal to about 0.1 nm to less than or equal to about 100 nm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an example schematic illustration of a capacitor-assisted battery having an electrode comprising one or more composite electroactive particles in accordance with various aspects of the present disclosure;

FIG. 2 is a close-up view of a composite electroactive particle in accordance with various aspects of the present disclosure;

FIG. 3 is an example schematic illustration of another capacitor-assisted battery in accordance with various aspects of the present disclosure;

FIG. 4 is a close-up view of an intermediate composite electroactive particle in accordance with various aspects of the present disclosure;

FIG. 5A is a chart illustrating energy capabilities of comparative capacitor-assisted batteries;

FIG. 5B is a chart illustrating the cycling performance of a capacitor-assisted electrode prepared in accordance with various aspects of the present disclosure; and

FIG. 5C is a chart illustrating estimated energy densities of a lithium-ion battery comparative and comparative capacitor-assisted batteries.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to electrochemical cells including sulfur-containing capacitors or hybrid supercapacitor-battery systems (e.g., capacitor-assisted batteries (“CAB”)), which integrate the high power density of capacitors with high energy density of lithium-ion batteries, that may be used in, for example, automotive or other vehicles (e.g., motorcycles, boats), but may also be used in electrochemical cells used in a variety of other industries and applications, such as consumer electronic devices, by way of non-limiting example.

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form.

In hybrid capacitor-battery systems (e.g., capacitor-assisted batteries), a capacitor may be integrated with the lithium-ion battery or cell stack. A capacitor may include one or more capacitor components or layers, such as a capacitor assisted negative electrode or anode, that are parallel or stacked with the one or more electrodes comprising the lithium-ion battery. The one or more capacitor components or layers may be integrated within a housing defining the lithium-ion battery or stack, such that a capacitor component is also in communication with the electrolyte of the lithium-ion battery. Each of the negative and positive electrodes and capacitor components within a hybrid battery pack or cell stack may be connected to a current collector (typically a metal, such as copper for the anode and/or capacitor-assisted anode and aluminum for the cathode). During battery usage, the current collectors associated with the (stacked) electrodes are connected by an external circuit that allows current generated by electrons to pass between the electrodes to compensate for transport of lithium ions.

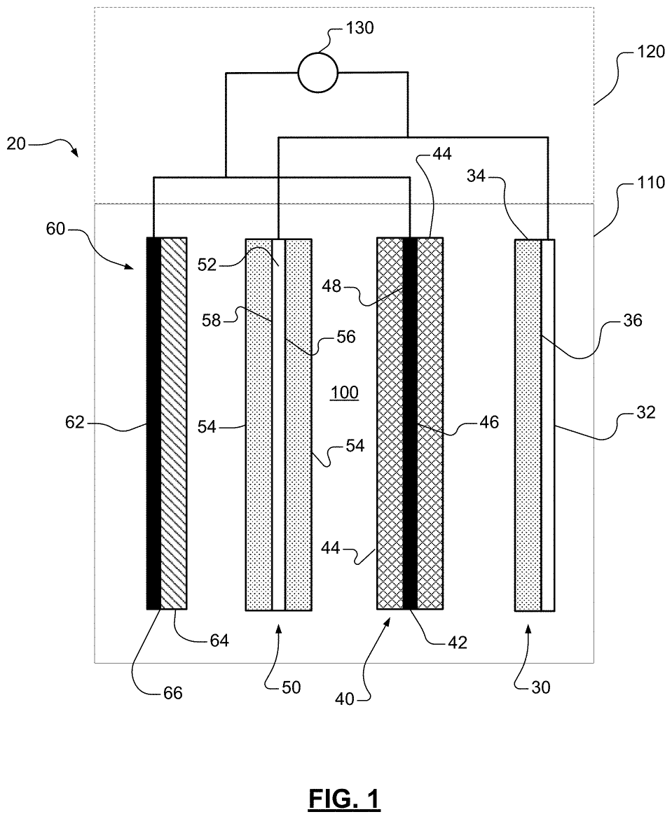

An exemplary and schematic illustration of a capacitor-assisted electrochemical cell (e.g. battery) 20 is shown in FIG. 1. The capacitor-assisted battery 20 includes at least two positive electrodes 30, 50; at least one negative electrode 40; and at least one composite (e.g., capacitor-assisted) electrode 60. The capacitor-assisted battery 20 may further includes an electrolyte 100. A first positive electrode 30 may be parallel with a second positive electrode 50 and a negative electrode 40 may be disposed therebetween. A composite electrode 60 may be parallel with a side or surface of the second positive electrode 50 that opposes the negative electrode 40. In certain aspects, as shown, the electrodes 30, 40, 50, 60 may be disposed within a single battery housing 110 containing an electrolyte 100. The skilled artisan will appreciate, however, that in various other aspects, other housing systems or designs may be present. For example, in certain variations, the first positive electrode 30 and the negative electrode 40 may be disposed within a first housing (e.g., a battery housing) having a first electrolyte, and the second positive electrode 50 and the composite electrode 60 may be disposed within a second housing (e.g., capacitor housing) having a second electrolyte. In such instances, the first electrolyte may be the same or different from the second electrolyte.

In various aspects, the capacitor-assisted battery 20 may include greater than or equal to about 1 wt. % to less than or equal to about 25 wt. %, and in certain aspects, optionally greater than or equal to about 3 wt. % to less than or equal to about 20 wt. %, of the electrolyte 100. Any appropriate electrolyte 100, whether in solid, liquid, or gel form, capable of conducting lithium ions between the electrodes 30, 40, 50, 60 may be used in the capacitor-assisted battery 20. For example, the electrolyte 100 may be a non-aqueous liquid electrolyte solution that includes a lithium salt dissolved in an organic solvent or a mixture of organic solvents. Numerous conventional non-aqueous liquid electrolyte solutions may be employed in the capacitor-assisted battery 20.

Appropriate lithium salts generally have inert anions. A non-limiting list of lithium salts that may be dissolved in an organic solvent or a mixture of organic solvents to form the non-aqueous liquid electrolyte solution include lithium hexafluorophosphate (LiPF₆); lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate)borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), and combinations thereof. In certain variations, the lithium salt is selected from lithium hexafluorophosphate (LiPF₆), lithium bis(trifluoromethanesulfonimide) (LiTF (LiN(CF₃SO₂)₂), lithium fluorosulfonylimide (LiN(FSO₂)₂) (LiFSI), and combinations thereof.

These and other similar lithium salts may be dissolved in a variety of organic solvents, including but not limited to various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethyl methyl carbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane (DME), 1-2-diethoxyethane, ethoxymethoxyethane), cyclic ethers (e.g., tetrahydrofuran, 2-methyltetrahydrofuran), 1,3-dioxolane (DOL)), sulfur compounds (e.g., sulfolane), and combinations thereof. In various aspects, the electrolyte 100 may include greater than or equal to 1M to less than or equal to about 2M concentration of the one or more lithium salts. In certain variations, for example when the electrolyte has a lithium concentration greater than about 2 M or ionic liquids, the electrolyte 100 may include one or more diluters, such as fluoroethylene carbonate (FEC) and/or hydrofluoroether (HFE).

In various aspects, the electrolyte 100 may be a solid-state electrolyte including one or more solid-state electrolyte particles that may comprise one or more polymer-based particles, oxide-based particles, sulfide-based particles, halide-based particles, borate-based particles, nitride-based particles, and hydride-based particles. Such a solid-state electrolyte may be disposed in a plurality of layers so as to define a three-dimensional structure. In various aspects, the polymer-based particles may be intermingled with a lithium salt so as to act as a solid solvent. In certain variations, the polymer-based particles may comprise one or more of polymer materials selected from the group consisting of: polyethylene glycol, poly(p-phenylene oxide) (PPO), poly(methyl methacrylate) (PMMA), polyacrylonitrile (PAN), polyvinylidene fluoride (PVDF), poly(vinylidene fluoride-co-hexafluoropropylene (PVDF-HFP), polyvinyl chloride (PVC), and combinations thereof. In one variation, the one or more polymer materials may have an ionic conductivity equal to about 10⁻⁴ S/cm.

In various aspects, the oxide-based particles may comprise one or more garnet ceramics, LISICON-type oxides, NASICON-type oxides, and Perovskite type ceramics. For example, the one or more garnet ceramics may be selected from the group consisting of: Li_{6.5}La₃Zr_{1.75}Te_{0.25}O₁₂, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, and combinations thereof. The one or more LISICON-type oxides may be selected from the group consisting of: Li₁₄Zn(GeO₄)⁴, Li₃₊ₓ(P₁₋ₓSiₓ)O₄ (where 0≤x≤1), Li₃₊ₓGeₓV₁₋ₓO₄ (where 0≤x≤1), and combinations thereof. The one or more NASICON-type oxides may be defined by LiMM′(PO₄)₃, where M and M′ are independently selected from Al, Ge, Ti, Sn, Hf, Zr, and La. For example, in certain variations, the one or more NASICON-type oxides may be selected from the group consisting of: Li₁₊ₓAlₓGe₂₋ₓ(PO₄)₃ (LAGP) (where 0≤x≤2), Li₁₊ₓAlₓTi₂₋ₓ(PO₄)₃ (LATP) (where 0≤x≤2), Li₁₊ₓYₓZr₂₋ₓ(PO₄)₃ (LYZP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The one or more Perovskite-type ceramics may be selected from the group consisting of: Li_{3.3}La_{0.53}TiO₃, LiSr_{1.65}Zr_{1.3}Ta_{1.7}O₉, Li_{2-x-y}Sr₁₋ₓTa_{y}Zr_{1-y}O₃ (where X=0.75y and 0.60≤y≤0.75), Li_{3/8}Sr_{7/16}Nb_{3/4}Zr_{1/4}O₃, Li₃ₓLa_{(2/3-x)}TiO₃ (where 0≤x≤0.25), and combinations thereof. In one variation, the one or more oxide-based materials may have an ionic conductivity greater than or equal to about 10⁻⁵ S/cm to less than or equal to about 10⁻³ S/cm.

In various aspects, the sulfide-based particles may include one or more sulfide-based materials selected from the group consisting of: Li₂S—P₂S₅, Li₂S—P₂S₅-MSₓ (where M is Si, Ge, and Sn and 0≤x≤2), Li_{3.4}Si_{0.4}P_{0.6}S₄, Li₁₀GeP₂S_{11.7}O_{0.3}, Li_{9.6}P₃S₁₂, Li₇P₃S₁₁, Li₉P₃S₉O₃, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li(Ge_{0.5}Sn_{0.5})P₂S₁₂, Li(Si_{0.5}Sn_{0.5})PₛS₁₂, Li₁₀GeP₂S₁₂ (LGPS), Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, L_{19.54}Si_{1.74}P_{1.44}S_{11.7}Cl_{0.3}, (1−x)P₂S₅-xLi₂S (where 0.5≤x≤0.7), and combinations thereof. In one variation, the one or more sulfide-based materials may have an ionic conductivity greater than or equal to about 10⁻⁷ S/cm to less than or equal to about 10⁻² S/cm.

In various aspects, the halide-based particles may include one or more halide-based materials selected from the group consisting of: Li₂CdCl₄, Li₂MgCl₄, Li₂CdI₄, Li₂ZnI₄, Li₃OCl, LiI, Li₅ZnI₄, Li₃OCl₁₋ₓBrₓ (where 0≤x≤1), and combinations thereof. In one variation, the one or more halide-based materials may have an ionic conductivity greater than or equal to about 10⁻⁸ S/cm to less than or equal to about 10⁻⁵ S/cm.

In various aspects, the borate-based particles may include one or more borate-based materials selected from the group consisting of: Li₂B₄O₇, Li₂O—(B₂O₃)—(P₂O₅), and combinations thereof. In one variation, the one or more borate-based materials may have an ionic conductivity greater than or equal to about 10'S/cm to less than or equal to about 10'S/cm.

In various aspects, the nitride-based particles may include one or more nitride-based materials selected from the group consisting of: Li₃N, Li₇PN₄, LiSi₂N₃, LiPON, and combinations thereof. In one variation, the one or more nitride-based materials may have an ionic conductivity greater than or equal to about 10⁻⁹ S/cm to less than or equal to about 10⁻³ S/cm.

In various aspects, the hydride-based particles may include one or more hydride-based materials selected from the group consisting of: Li₃AlH₆, LiBH₄, LiBH₄—LiX (where X is one of Cl, Br, and I), LiNH₂, Li₂NH, LiBH₄—LiNH₂, and combinations thereof. In one variation, the one or more hydride-based materials may have an ionic conductivity greater than or equal to about 10'S/cm to less than or equal to about 10'S/cm.

In still further variations, the electrolyte 100 may be a quasi-solid electrolyte comprising a hybrid of the above detailed non-aqueous liquid electrolyte solution and solid-state electrolyte systems—for example including one or more ionic liquids and one or more metal oxide particles, such as aluminum oxide (Al₂O₃) and/or silicon dioxide (SiO₂).

With renewed reference to FIG. 1, in various aspects, the first positive electrode 30 may include a first positive current collector 32 and one or more first positive electroactive material layers 34. The one or more first positive electroactive material layers 34 may be disposed in electrical communication with the first positive current collector 32. For example, the first positive electroactive material layer 34 may be disposed at or near one or more parallel surfaces of the first positive current collector 32. As illustrated, a first positive electroactive material layer 34 may be disposed at or near a first surface 36 of the first positive current collector 32. The first surface 36 of the first positive current collector 32 may face the negative electrode 40.

In various aspects, the second positive electrode 50 may include a second positive current collector 52 and one or more second positive electroactive material layers 54. The one or more second positive electroactive material layers 54 may be disposed in electrical communication with the second positive current collector 52. For example, the second positive electroactive material layer 54 may be disposed at or near one or more parallel surfaces of the second positive current collector 52. As illustrated, a second positive electroactive material layer 54 may be disposed at or near a first surface 56 of the second positive current collector 52, and a second positive electroactive material layer 54 may be disposed at or near a second surface 58 of the second positive current collector 52. The first surface 56 of the second positive current collector 52 may face the negative electrode 40. The second surface 58 of the second positive current collector 52 may face the composite electrode 60.

The one or more first positive electroactive material layers 34 and the one or more second positive electroactive material layers 54 may each comprise a lithium-based positive electroactive material that is capable of undergoing lithium intercalation and deintercalation, alloying and dealloying, or plating and stripping, while functioning as a positive terminal of the capacitor-assisted battery 20. In various aspects, the one or more first positive electroactive material layers 34 may comprise the same or different lithium-based positive electroactive material as the one or more second positive electroactive material layers 54. For example, each of the one or more first positive electroactive material layers 34 and the one or more second positive electroactive material layers 54 may be defined by a plurality of positive electroactive particles (not shown) comprising one or more transition metal cations, such as manganese (Mn), nickel (Ni), cobalt (Co), chromium (Cr), iron (Fe), vanadium (V), and combinations thereof. Independent pluralities of such positive electroactive particles may be disposed in layers to define the three-dimensional structures of the one or more first positive electroactive material layers 34 and the one or more second positive electroactive material layers 54. In certain variations, the one or more first positive electroactive material layers 34 and the one or more second positive electroactive material layers 54 may further include electrolyte 100, for example a plurality of electrolyte particles (not shown). The one or more first positive electroactive material layers 34 and/or the one or more second positive electroactive material layers 54 may each have a thickness greater than or equal to about 1 μm to less than or equal to about 1000 μm.

In various aspects, the one or more first positive electroactive material layers 34 and the one or more second positive electroactive material layers 54 may each be one of a layered-oxide cathode, a spinel cathode, and a polyanion cathode. For example, layered-oxide cathodes (e.g., rock salt layered oxides) comprises one or more lithium-based positive electroactive materials selected from LiCoO₂ (LCO), LiNiₓMn_{y}Co_{1-x-y}O₂ (where 0≤x≤1 and 0≤y≤1), LiNi_{1-x-y}CoₓAl_{y}O₂ (where 0≤x≤1 and 0≤y≤1), LiNiₓMn₁₋ₓO₂ (where 0≤x≤1), and Li₁₊ₓMO₂ (where M is one of Mn, Ni, Co, and Al and 0≤x≤1). Spinel cathodes comprise one or more lithium-based positive electroactive materials selected from LiMn₂O₄ (LMO) and LiNiₓMn_{1.5}O₄. Olivine type cathodes comprise one or more lithium-based positive electroactive material LiMPO₄ (where M is at least one of Fe, Ni, Co, and Mn). Polyanion cations include, for example, a phosphate such as LiV₂(PO₄)₃ and/or a silicate such as LiFeSiO₄. In this fashion, the one or more first positive electroactive material layers 34 and the one or more second positive electroactive material layers 54 may each (independently) include one or more lithium-based positive electroactive materials selected from the group consisting of: LiCoO₂ (LCO), LiNiₓMn_{y}Co_{1-x-y}O₂ (where 0≤x≤1 and 0≤y≤1), LiNi_{1-x-y}CoₓAl_{y}O₂ (where 0≤x≤1 and 0≤y≤1), LiNiₓMn₁₋ₓO₂ (where 0≤x≤1), Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), and combinations thereof.

In various aspects, the one or more lithium-based positive electroactive materials may be optionally coated (for example by LiNbO₃ and/or Al₂O₃) and/or may be doped (for example by magnesium (Mg)). Further, in certain variations, the one or more lithium-based positive electroactive materials may be optionally intermingled with—the one or more first positive electroactive material layers 34 and the one or more second positive electroactive material layers 54 may optionally include—one or more electrically conductive materials that provide an electron conductive path and/or at least one polymeric binder material that improves the structural integrity of the respective positive electrode 30, 50. For example, the one or more first positive electroactive material layers 34 and/or the one or more second positive electroactive material layers 54 may include greater than or equal to about 30 wt. % to less than or equal to about 98 wt. % of the one or more lithium-based positive electroactive materials; greater than or equal to about 0 wt. % to less than or equal to about 30 wt. % of electrically conductive materials; and greater than or equal to about 0 wt. % to less than or equal to about 20 wt. %, and in certain aspects, optionally greater than or equal to about 1 wt. % to less than or equal to about 20 wt. %, of a binder.

The one or more first positive electroactive material layers 34 and/or the one or more second positive electroactive material layers 54 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

The first and second positive current collectors 32, 52 may facilitate the flow of electrons between the positive electrodes 30, 50 and an exterior circuit. For example, an interruptible external circuit 120 and a load device 130 may connect the first positive electrode 30 (through the first positive current collector 32) and the second positive electrode 50 (through the second positive current collector 52). The positive current collectors 32, 52 may include metal, such as a metal foil, a metal grid or screen, or expanded metal. For example, the positive current collectors 32, 52 may be formed from aluminum and/or nickel or any other appropriate electrically conductive materials known to those of skill in the art. In various aspects, the first and second positive current collectors 32, 52 may be the same or different.

In various aspects, the negative electrode 40 may include a first negative current collector 42 and one or more first negative electroactive material layers 44. The one or more first negative electroactive material layers 44 may be disposed in electrical communication with the first negative current collector 42. For example, the one or more first negative electroactive material layers 44 may be disposed at or near one or more parallel surfaces of the first negative current collector 42. As illustrated, a first negative electroactive material layer 44 may be disposed both at or near a first surface 46 of the first negative current collector 42, and a first negative electroactive material layer 44 may be disposed at or near a second surface 48 of the first negative current collector 42. The first surface 46 of the first negative current collector 42 may face the first positive electrode 30. The second surface 48 of the first negative current collector 42 may face the second positive electrode 50.

Like the positive current collectors 32, 52, the first negative current collector 42 may include metal, such as a metal foil, a metal grid or screen, or expanded metal. For example, the first negative current collector 42 may be formed from copper or any other appropriate electrically conductive material known to those of skill in the art. The one or more first negative electroactive material layers 44 may comprise a lithium host material (e.g., negative electroactive material) that is capable for functioning as a negative terminal of the capacitor-assisted battery 20. The one or more first negative electroactive material layers 44 may be defined by a plurality of negative electroactive particles (not shown) that are lithium based, for example, a lithium metal and/or lithium alloy; silicon based, comprising, for example, a silicon or silicon alloy or silicon oxide mixed, in certain instances, with graphite; carbonaceous material, comprising, for example, one or more of activated carbon (AC), hard carbon (HC), soft carbon (SC), graphite, graphene, and carbon nanotubes (“CNTs”); and/or comprising one or more lithium-accepting anode materials such as lithium titanium oxide (Li₄Ti₅O₁₂), one or more transition metals (such as tin (Sn)), one or more metal oxides (such as vanadium oxide (V₂O₅), titanium dioxide (TiO₂)), titanium niobium oxide (TiₓNb_{y}O_{z}, where 0≤x≤2, 0≤y≤24, and 0≤z≤64), and one or more metal sulfides (such as ferrous sulfide (FeS)).

In this fashion, the one or more first negative electroactive material layers 44 may each (independently) include a negative electroactive material selected from the group consisting of: lithium metal, lithium alloy, silicon (Si), silicon alloy, silicon oxide, activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z}, where 0≤x≤2, 0≤y≤24, and 0≤z≤64), ferrous sulfide (FeS), and combinations thereof. Independent pluralities of such negative electroactive particles may be disposed in layers to define the three-dimensional structures of the one or more first negative electroactive material layers 44. In certain variations, the one or more first negative electroactive material layers 44 may further include electrolyte 100, for example a plurality of electrolyte particles (not shown). The one or more first negative electroactive material layers 44 may each have a thickness greater than or equal to about 1 μm to less than or equal to about 1000 μm.

In various aspects, the one or more negative electroactive materials may be optionally intermingled with—the one or more one or more first negative electroactive material layers 44 may optionally include—one or more electrically conductive materials that provide an electron conductive path and/or at least one polymeric binder material that improves the structural integrity of the negative electrode 40. For example, the one or more first negative electroactive material layers 44 may include greater than or equal to about 0 wt. % to less than or equal to about 99 wt. % of the negative electroactive material; greater than or equal to about 0 wt. % to less than or equal to about 30 wt. % of electrically conductive materials; and greater than or equal to about 0 wt. % to less than or equal to about 20 wt. %, and in certain aspects, optionally greater than or equal to about 1 wt. % to less than or equal to about 20 wt. % of a binder.

The one or more first negative electroactive material layers 44 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

In various aspects, the composite electrode 60 may include a second negative current collector 62 and one or more second negative electroactive material layers 64. The one or more second negative electroactive material layers 64 may disposed in electrical communication with the second negative current collector 62. For example, the one or more second negative electroactive material layers 64 may be disposed at or near one or more parallel surfaces of the second negative current collector 62. As illustrated, a second negative electroactive material layer 64 may be disposed on a first surface 66 of the second negative current collector 42. The first surface 66 of the second negative current collector 62 may face the second positive electrode 50.

Like the first negative current collector 42, the second negative current collector 62 may include metal, such as a metal foil, a metal grid or screen, or expanded metal. For example, the second negative current collector 62 may be formed from copper or any other appropriate electrically conductive material known to those of skill in the art. The second negative current collector 62 may be same or different from the first negative current collector 42. The first and second negative current collectors 42, 62 may facilitate the flow of electrons between the negative electrodes 40, 60 and the exterior circuit 120. For example, the interruptible external circuit 120 and a load device 130 may connect the first negative electrode 40 (through the first negative current collector 42) and the second negative electrode 60 (through the second positive current collector 62).

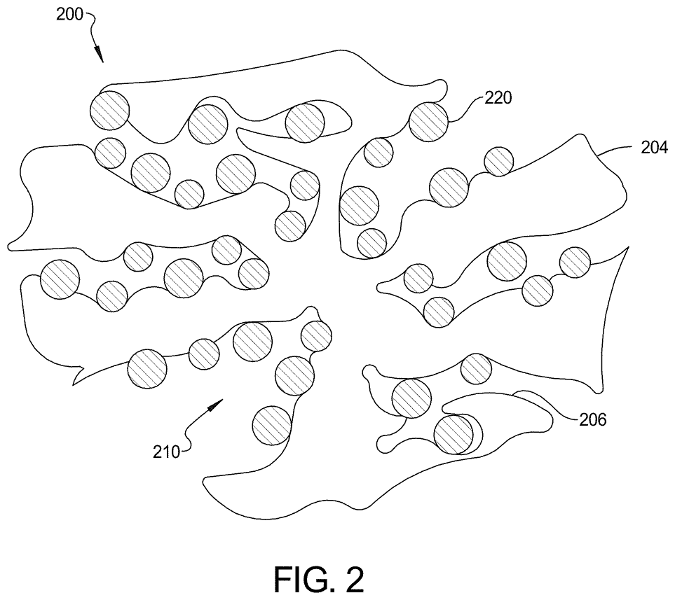

The one or more second negative electroactive material layers 64 in FIG. 1 may comprise a plurality of porous composite negative electroactive particles 200, as illustrated in FIG. 2. The composite negative electroactive particles 200 each define a body 204 that defines a plurality of pores 210. The body 204 is formed of a negative electroactive material. For example, the body 204 may comprise one or more of a carbonaceous material (e.g., activated carbon, hard carbon, soft carbon) and/or a metal oxide (e.g., titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂)). Such materials, for example activated carbon, may further enhance the power capability of the battery 20. However, many of these materials have comparatively large surface areas, for example activated carbon (AC) has a representative surface area of about 1,489 m²/g. The presence of such particles having increased surface area may in certain instances give rise to increased electrolyte requirements or demands (e.g., greater than or equal to about 5 wt. % of the electrolyte) such that the energy density of the battery 20 is negatively affected when they are present.

In accordance with various aspects of the present disclosure, the composite negative electroactive particles 200 may further comprise one or more sulfur-additive particles 220. Such sulfur additives, as further detailed below, when incorporated into pores 210 of the composite negative electroactive particles 200 may enhance the energy density of a capacitor-assisted battery 20 when they are incorporated into the one or more second negative electroactive material layers 64. For example, a thickness of the one or more second negative electroactive material layers 64 may be reduced as compared to a typical capacitor layer due to the presence of sulfur-additive particles that enhance the electrochemical performance.

In various aspects, the plurality of composite negative electroactive particles 200 may be disposed in layers to define the one or more second negative electroactive material layers 64. In certain aspects, the one or more second negative electroactive material layers 64 may further include one or more second negative electroactive particles (not shown) comprising one or more negative electroactive materials selected from the group consisting of: lithium metal, lithium alloy, silicon (Si), silicon alloy, silicon oxide activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof. For example, the one or more negative electroactive material layers 64 may greater than or equal to about 0.01 wt. % to less than or equal to about 99.99 wt. % of the composite negative electroactive particles 200 and greater than or equal to about 0.01 wt. % to less than or equal to about 99.99 wt. % of the one or more second negative electroactive particles.

In various aspects, the one or more second negative electroactive material layers 64 may have a thickness greater than or equal to about 1 μm to less than or equal to about 1000 μm, and in certain aspects, optionally greater than or equal to about 1 μm to less than or equal to about 500 μm. In various aspects, the one or more second negative electroactive material layers 64 may further include electrolyte 100, for example a plurality of electrolyte particles or a liquid electrolyte (not shown); and the one or more second negative electroactive material layers 64 may optionally include one or more electrically conductive materials (not shown) that provide an electron conductive path and/or at least one polymeric binder material (not shown) that improves the structural integrity of the negative electrode 40. For example, the one or more second negative electroactive material layers 64 may include greater than or equal to about 0 wt. % to less than or equal to about 99 wt. % of the composite negative electroactive particles 200; greater than or equal to about 0 wt. % to less than or equal to about 99 wt. % of the one or more second negative electroactive particles; greater than or equal to about 0 wt. % to less than or equal to about 30 wt. % of electrically conductive materials; and greater than or equal to about 1 wt. % to less than or equal to about 20 wt. % of a binder.

For example, the one or more second negative electroactive material layers 64 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

With renewed reference to FIG. 2, each composite negative electroactive particle 200 may have the plurality of pores 210. For example, each composite negative electroactive particle 200 may have an average particle size greater than or equal to about 1 nm to less than or equal to about 1000 μm, and in certain aspects, optionally greater than or equal to about 10 nm to less than or equal to about 500 μm. Each composite negative electroactive particle 200 may have a porosity greater than or equal to about 0 vol. % to less than or equal to about 100 vol. %, and in certain aspects, optionally greater than or equal to about 5 vol. % to less than or equal to about 80 vol. %. Each composite negative electroactive particle 200 may have a mesoporous structure, where an average pore diameter may be greater than or equal to about 0.1 nm to less than or equal to about 500 nm, and in certain aspects, optionally greater than or equal to about 1 nm to less than or equal to about 100 nm.

The composite negative electroactive particles 200 may further include a plurality of sulfur-additive particles 220. The composite negative electroactive particles 200 including the plurality of sulfur-additive particles 220 may be incorporated into the one or more second electroactive material layers 64 as shown in FIG. 1. In certain aspects, the sulfur-additive particles 220 may be elemental sulfur particles. The plurality of sulfur-additive particles 220 may be disposed or embedded within each of the plurality of pores 210 of the composite negative electroactive particle 200. As illustrated, the sulfur-additive particles 220 may be disposed or embedded at or near a plurality of interior walls 206 defining each pore 210. The sulfur-additive particles 220 may occupy greater than or equal to about 0.01 vol. % to less than or equal to about 100 vol. %, and in certain aspects, optionally greater than or equal to about 5 vol. % to less than or equal to about 80 vol. %, of the total pore volume of each negative electroactive particle 200. An average particle size of the sulfur-additive particles 200 may be greater than or equal to about 0.1 nm to less than or equal to about 500 nm, and in certain aspects, optionally greater than or equal to about 1 nm to less than or equal to about 100 nm. Notably, the average particle size of the sulfur-additive particles 200 is smaller than the average pore size of the respective pore 210 in which the sulfur-additive particle 200 is embedded. The sulfur-additive particles 220 may reduce a total amount of exposed surface area of each negative electroactive particle 200 by greater than or equal to about 0% to less than or equal to about 100%, and in certain aspects, optionally greater than or equal to about 0.01% to less than or equal to about 50%. The capacitor-assisted battery 20, including the composite negative electroactive particle 200 and sulfur-additive particles 220, may include greater than or equal to about 1 wt. % to less than or equal to about 20 wt. %, and in certain aspects, optionally greater than or equal to about 3 wt. % to less than or equal to about 15 wt. %, of the electrolyte 100.

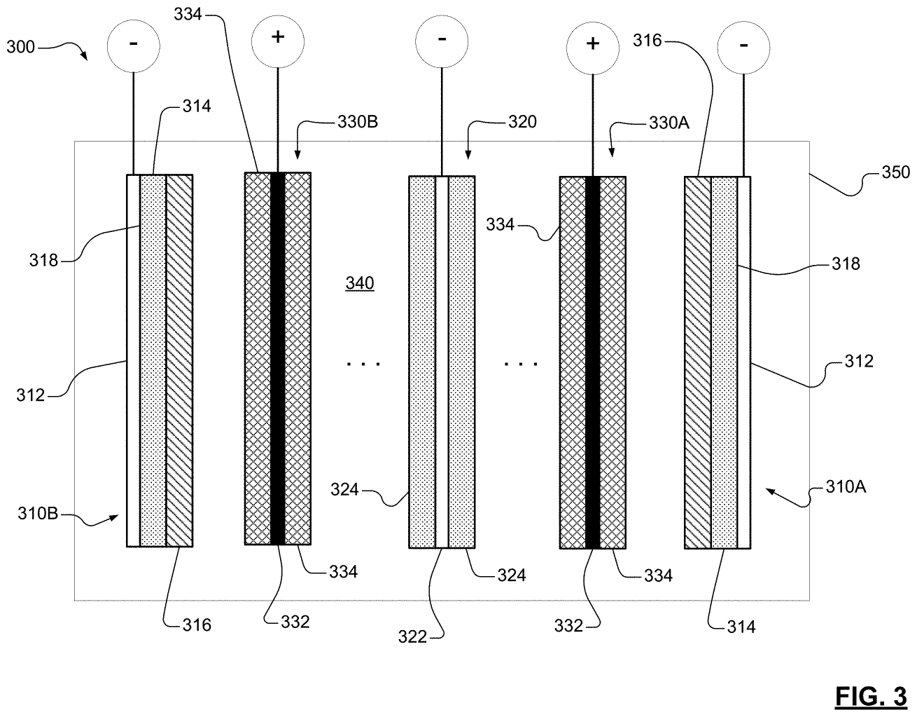

In various aspects, the embodiments shown are representative, but not necessarily limiting, of capacitor-assisted battery configurations that incorporate at least one composite electrode prepared in accordance with the present teachings. Thus, the composite electrodes prepared in accordance with certain aspects of the present disclosure may be employed in other design configurations to provide the capacitor-assisted electrochemical cell. Thus, the skilled artisan will appreciate that the features detailed with respect to the capacitor-assisted battery 20 illustrated in FIG. 1 may apply to various other electrochemical devices and structures, including, for example, in cells or stacks having additional layers or additional positive and negative electrodes and/or composite (e.g., capacitor-assisted) electrodes. Further, the skilled artisan will recognize that details illustrated in FIG. 1 extend also to various stacked configurations. For example, in various aspects, a composite electrode may be disposed between a first positive electrode and a second positive electrode. In such instances, a first negative electrode may be parallel with a first surface of the first positive electrode, where the first surface of the first positive electrode opposes the composite electrode. A second negative electrode may be parallel with a first surface of the second positive electrode, where the first surface of the second positive electrode opposes the composite electrode. In other variations, a first composite (e.g., capacitor-assisted) electrode may form a first terminal electrode of a capacitor-assisted battery and a second composite (e.g., capacitor-assisted) electrode may form a second terminal electrode of a capacitor-assisted battery. In still other variations, a first composite electroactive particles may be intermingled with negative electroactive particles and together disposed to form one or more negative electroactive material layers and/or electrodes. Further, in other variations, a composite electrode may form an inner most electrode. Further still, as illustrated in FIG. 3, a capacitor-assisted electroactive material layer may be disposed on one or more surfaces of a negative electroactive material layer.

The capacitor-assisted battery 300 includes one or more composite (e.g., capacitor-assisted) electrodes 310A, 310B; at least one negative electrode 320; and at least two positive electrodes 330A, 330B. A first composite electrode 310A may be parallel with a first positive electrode 330A, and a second composite negative electrode 310B may be parallel with a second positive electrode 330B. A negative electrode 320 may be disposed between the first and second positive electrodes 330A, 330B. As indicated by the ellipsis, in various aspects, the capacitor-assisted battery 300 may include one or more additional positive electrodes, negative electrodes, and/or composite (e.g., capacitor-assisted) electrodes (such as that described in the present instance, or above with respect to FIG. 1). Similar to composite electrode 60, the first and second composite electrodes 310A, 310B; the negative electrode 320; and the first and second positive electrodes 330A, 330B may be disposed within a single battery housing 350 containing electrolyte 340. The capacitor-assisted battery 300 may include greater than or equal to about 1 wt. % to less than or equal to about 20 wt. %, and in certain aspects, optionally greater than or equal to about 3 wt. % to less than or equal to about 15 wt. %, of the electrolyte 340.

The composite electrodes 310A, 310B may each comprise a first negative current collector 312; one or more first negative electroactive material layers 314; and one or more composite material layers 316. The first negative current collector 312 may be a metal foil, metal grid or screen, or expanded metal comprising copper or any other appropriate electrically conductive material known to those of skill in the art. The one or more first negative electroactive material layers 314 and the one or more composite material layers 316 may be in electrical communication with the first negative current collector 312. For example, a first negative electroactive material layer 314 may be disposed at or near one or more parallel surfaces of the first negative current collector 312 and a composite material layer 316 may be disposed at or near one or more exposed surfaces of the one or more first negative electroactive material layers 314. As illustrated, a first negative electroactive material layer 314 may be disposed at or near a first surface 318 of the first negative current collector 312, and a composite material layer 316 may be disposed on a surface of the first negative electroactive material 314 distant from the first negative current collector 312. The skilled artisan will appreciate that the composite electrodes 310A, 310B may have various other structures. For example, the composite material layer 316 may be disposed at or near one or more parallel surfaces of the first negative current collector 312 and the first negative electroactive material layer 314 may be disposed at or near one or more exposed surfaces of the composite material layer 316.

The one or more first negative electroactive material layers 314 may each (independently) include a negative electroactive material selected from the group consisting of: lithium metal, lithium alloy, silicon (Si), silicon alloy, silicon oxide activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z}, where 0≤x≤2, 0≤y≤24, and 0≤z≤64), ferrous sulfide (FeS), and combinations thereof. Independent pluralities of negative electroactive material may be disposed in layers to define the three-dimensional structures of the one or more first negative electroactive material layers 314.

The one or more composite material layers 316 may include a plurality of composite negative electroactive particles (such as the composite negative electroactive particles illustrated in FIG. 2) disposed in layers to create the one or more second negative electroactive material layers 64. As noted above, the composite negative electroactive particles may comprise one or more of a carbonaceous material (e.g., activated carbon, hard carbon, soft carbon) and/or a metal oxide (e.g., titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂)) and have a plurality of pores. A plurality of sulfur-additive particles may be disposed or embedded within each of the plurality of pores.

The positive electrodes 330A may each comprise a positive current collector 332 and one or more positive electroactive material layers 334. The positive current collector 332 may be a metal foil, metal grid or screen, or expanded metal comprising aluminum or any other appropriate electrically conductive material known to those of skill in the art. The one or more positive electroactive material layers 334 may be in electrical communication with the positive current collector 332. For example, a positive electroactive material layer 334 may be disposed at or near one or more parallel surfaces of the positive current collector 332. As illustrated, a positive electroactive material layer 334 may be disposed at or near both parallel lengths of the positive current collector 332.

The one or more positive electroactive material layers 334 may each (independently) include one or more lithium-based positive electroactive materials selected from the group consisting of: LiCoO₂ (LCO), LiNiₓMn_{y}Co_{1-x-y}O₂ (where 0≤x≤1 and 0≤y≤1), LiNi_{1-x-y}CoₓAl_{y}O₂ (where 0≤x≤1 and 0≤y≤1) LiNiₓMn₁₋ₓO₂ (where 0≤x≤1), Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), and combinations thereof. Independent pluralities of the lithium-based positive electroactive materials may be disposed in layers to define the three-dimensional structures of the one or more positive electroactive material layers 334

The negative electrode 320 comprises a second negative current collector 322 and one or more second negative electroactive material layers 324. The second negative current collector 322 may be the same or different from the first negative current collector 312. For example, the second negative current collector 322 may be a metal foil, metal grid or screen, or expanded metal comprising copper or any other appropriate electrically conductive material known to those of skill in the art. The one or more second negative electroactive material layers 324 may be in electrical communication with the second negative current collector 322. For example, a second negative electroactive material layer 324 may be disposed at or near one or more parallel surfaces of the second negative current collector 322. As illustrated, a second negative electroactive material layer 324 may be disposed at or near both parallel lengths of the second negative current collector 322.

The one or more second negative electroactive material layers 324 may each (independently) include a negative electroactive material selected from the group consisting of: lithium metal, lithium alloy, silicon (Si), silicon alloy, activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z}, where 0≤x≤2, 0≤y≤24, and 0≤z≤64), ferrous sulfide (FeS), and combinations thereof. Independent pluralities of negative electroactive materials may be disposed in layers to define the three-dimensional structures of the one or more second negative electroactive material layers 324.

In various aspects, the present disclosure provides a method for preparing composite electroactive particles, such as the composite electroactive particle illustrated in FIG. 2. The method for preparing composite electroactive particles may include admixing one or more electroactive precursors (such as activated carbon) and sulfur-additive precursor, for example using a milling or ball mill process. The admixture may comprise greater than or equal to about 0.01 wt. % to less than or equal to about 99.99 wt. % of the sulfur-additive precursor.

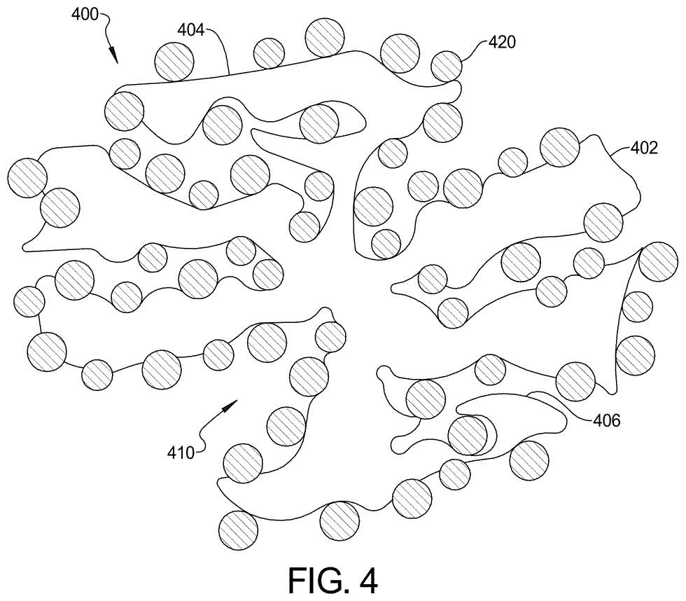

When the admixture is exposed to a first temperature greater than or equal to about 112.8° C. to less than or equal to about 450° C., and in certain aspects, optionally about 155° C., for a (first) time or duration of greater than or equal to about 1 hour to less than or equal to about 24 hours, optionally greater than or equal to about 1 hour to less than or equal to about 10 hours, and in certain aspects, optionally greater than or equal to about 1 hour to less than or equal to about 4 hours, an intermediate composite electroactive particle may be formed. As illustrated in FIG. 4, the intermediate capacitor-assisted electroactive material 400 may comprise a negative electroactive particle body 402 having a plurality of pores 410. Similar to FIG. 2, a plurality of sulfur-additive particles 420 may be disposed or embedded at or near interior walls 406 defining each pore 410. The intermediate capacitor-assisted electroactive material 400 may also include, however, a plurality of sulfur-additive particles 420 disposed or embedded at or near exterior walls 404 of the negative electroactive particle 402. In certain variations, such exterior-facing sulfur-additive particles 420 may undesirably induce a charge-discharge plateau, for example at about 2.1V. Such results may be substantially eliminated by exposing the intermediate capacitor-assisted electroactive material 400 to a second heat treatment.

When the intermediate capacitor-assisted electroactive material 400 is exposed to a second temperature greater than or equal to about 112.8° C. to less than or equal to about 450° C., and in certain aspects, optionally about 300° C., for a (second) time or duration greater than or equal to about 0.5 hour to less than or equal to about 24 hours, optionally greater than or equal to about 0.5 hour to less than or equal to about 10 hours, and in certain aspects, optionally greater than or equal to about 0.5 hour to less than or equal to about 4 hours, the composite electroactive particle, such as illustrated in FIG. 2, may be formed. This first and/or second heat treatment may occur in a sealed container. The formed composite electroactive particle may be integrated into a variety of capacitor-assisted battery structures, such as those illustrated in FIGS. 1 and 3.

Various aspects of the inventive technology can be further understood by the specific examples contained herein. Specific non-limiting examples are provided for illustrative purposes only of how to make and/or use the compositions, devices, and methods according to the present teachings and, unless explicitly stated otherwise, are not intended to be a representation that given combinations have, or have not, been made or tested. For example, comparative batteries are tested in a variety of environments.

### Example 1

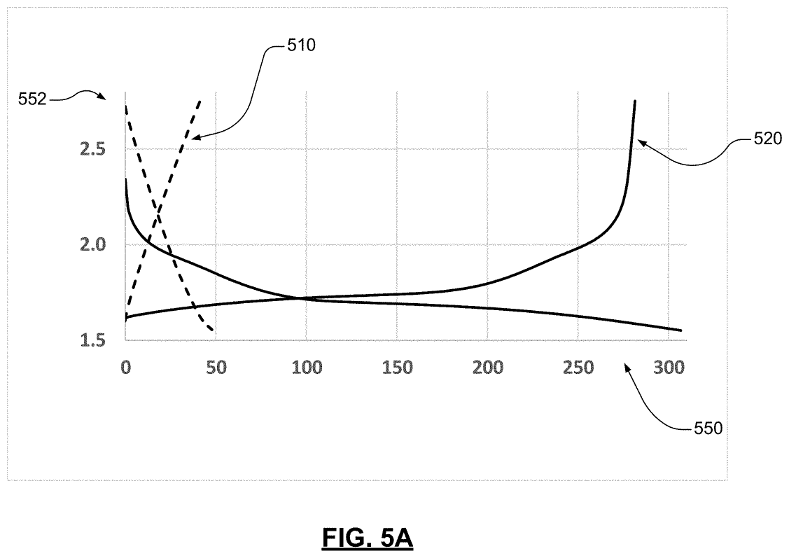

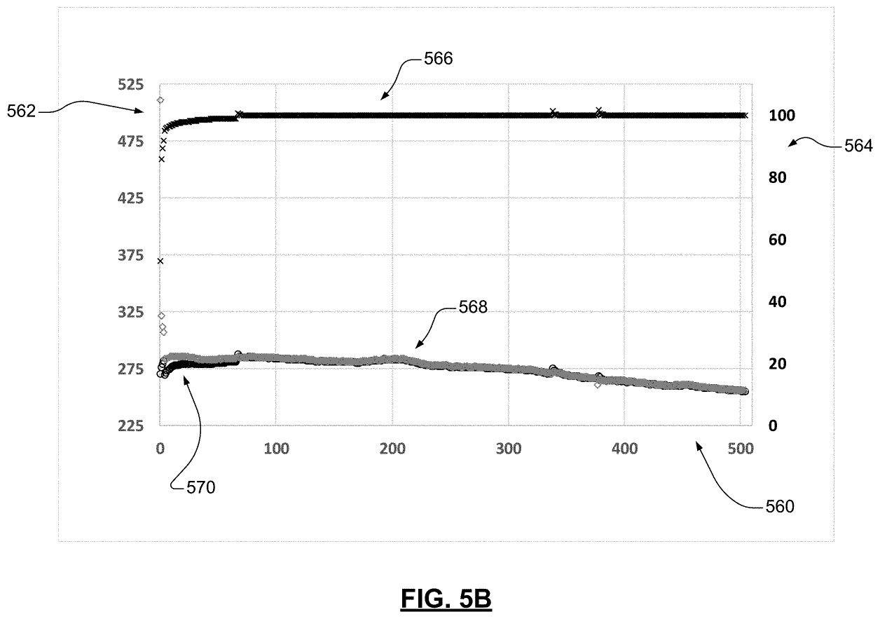

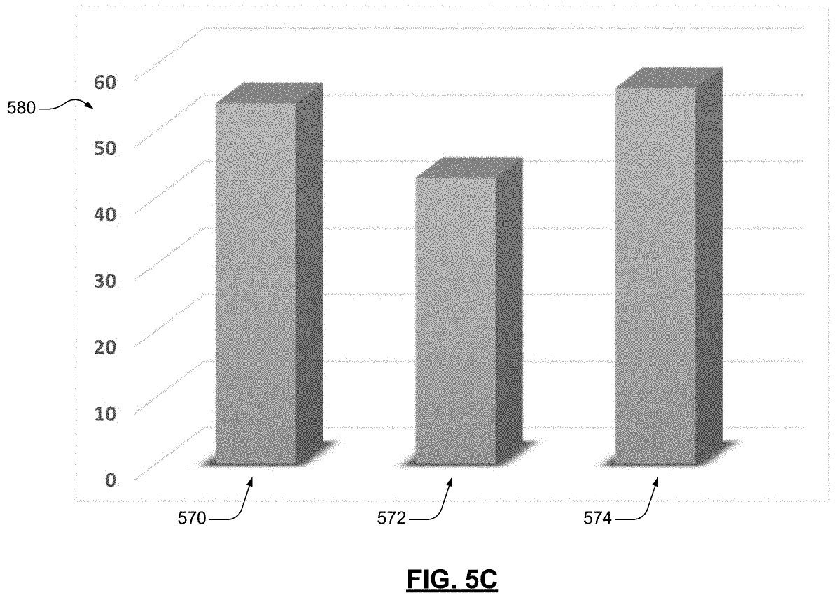

FIG. 5A shows the energy capabilities of the two comparative cells 510, 520 at 25° C. The first comparative cell 510 is a half coin cell comprising activated carbon and lithium. The second comparative cell 520 is a half coin cell comprising activated carbon and a sulfur additive in accordance with various aspects of the present disclosure. For example, the second comparative cell 520 may comprise about 20 wt. % of the sulfur additive. In each instance, the electroactive material—the activated carbon or activated carbon with the sulfur additive—is present with one or more conductive materials and one or more binders (e.g. PVDF). A weight ratio of the electroactive material with the one or more conductive materials and the one or more binders may be 8:1:1. Each cell 510, 520 may further comprise 1M lithium bis(trifluoromethanesulfonimide) (LiTFSI) (LiN(CF₃SO₂)₂) in a solvent mixture comprising 1,3-dioxolane (DOL) and 1,2-dimethoxyethane (DME).

The x-axis 550 represents discharge capacity (mAh/g) and the y-axis 552 represents voltage (V). As illustrated, the second comparative cell 520, including a sulfur-assisted electroactive material in accordance with various aspects of the present disclosure, has improved charge-discharge capacity compared to the first comparative cell 510. For example, as illustrated, the second comparative cell 520 may have a discharge capacity (e.g., about 300 mAh/g) that is five times larger than a discharge capacity (e.g., about 50 mAh/g) of the first comparative cell 510.

### Example 2

FIG. 5B shows the cycling performance of the second comparative cell 520 over 550 cycles at 25° C. The x-axis 560 represents the cycle number. The first y-axis 562 represents capacity (mAh/g), and the second y-axis 564 represents columbic efficiency (%). As such, line 566 shows the columbic efficiency (CE); line 568 shows the discharge capacity; and line 570 shows charge capacity.

### Example 3

FIG. 5C compares the estimated energy densities of the three comparative cells. The first comparative cell 570 is a lithium-ion battery. The second comparative cell 572 is a capacitor-assisted battery, and the third comparative cell 574 is a capacitor-assisted battery including a sulfur-assisted electroactive material in accordance with various aspects of the present disclosure. In each instance, a cathode comprises LMn₂O₄ (LMO) and a first anode comprise lithium titanium oxide (LTO). The comparative cells 570, 572, 574 are normalized with a capacity of 0.6 Ah and 8.22% capacitor hybrid ratio for cells 572 and 574.

The y-axis 580 represents energy density in Wh/Kg. As illustrated, the third comparative cell 574 including the composite electrode in accordance with various aspects of the present disclosure has an energy density of about 56.50 Wh/Kg, which is greater than about a 31% advantage over the corresponding second comparative cell 572 having an energy density of about 43.00 Wh/Kg and greater than about a 4% advantage over the corresponding first comparative cell 570. As such, the composite electrode in accordance with various aspects of the present disclosure greatly enhances the energy density of the capacitor-assisted battery.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A capacitor-assisted electrochemical cell comprising:
at least two first electrodes comprising one or more positive electroactive material layers disposed in electrical communication with a positive current collector;
at least one second electrode comprising one or more first negative electroactive material layers disposed in electrical communication with a first negative current collector; and
at least one composite electrode comprising one or more second negative electroactive material layers disposed in electrical communication with a second negative current collector, wherein the second negative electroactive material layers comprise a plurality of negative electroactive particles comprising one or more of a carbonaceous material and a metal oxide, and wherein each negative electroactive particle has a plurality of pores and a plurality of sulfur-additive particles disposed within the plurality of pores.

2. The capacitor-assisted electrochemical cell of claim 1, wherein the negative electroactive particles have an average particle size greater than or equal to about 1 nm to less than or equal to about 1000 μm and a porosity greater than or equal to about 5 vol. % to less than or equal to about 80 vol. %, wherein sulfur-additive particles occupy greater than or equal to about 0.01 vol. % to less than or equal to about 100 vol. % of a total pore volume of each negative electroactive particle.

3. The capacitor-assisted electrochemical cell of claim 1, wherein the pores have an average diameter greater than or equal to about 0.1 nm to less than or equal to about 500 nm and the sulfur-additive particles have an average particle size greater than or equal to about 0.1 nm to less than or equal to about 500 nm.

4. The capacitor-assisted electrochemical cell of claim 1, wherein the at least one composite electrode has a thickness greater than or equal to about 1 μm to less than or equal to about 500 μm.

5. The capacitor-assisted electrochemical cell of claim 1, wherein the at least one composite electrode further comprises one or more additional negative electroactive materials selected from the group consisting of: lithium metal, lithium alloy, silicon (Si), silicon alloy, silicon oxide activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

6. The capacitor-assisted electrochemical cell of claim 5, wherein the one or more additional negative electroactive materials are provided in one or more third negative electroactive material layers.

7. The capacitor-assisted electrochemical cell of claim 6, wherein the one or more third negative electroactive material layers are one of disposed between the one or more second negative electroactive material layers and the second negative current collector and disposed on one or more exposed surfaces of the of the one or more second negative electroactive material layers when the one or more second negative electroactive material layers are disposed on the one or more exposed surfaces of the second negative current collector.

8. The capacitor-assisted electrochemical cell of claim 1, wherein the at least one composite electrode further comprises one or more third negative electroactive material layers,
wherein the one or more third negative electroactive material layers comprise one or more negative electroactive materials selected from the group consisting of: lithium metal, lithium alloy, silicon (Si), silicon alloy, silicon oxide activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof; and the one or more third negative electroactive material layers are one of disposed between the one or more second negative electroactive material layers and the second negative current collector and disposed on one or more exposed surfaces of the of the one or more second negative electroactive material layers when the one or more second negative electroactive material layers are disposed on the one or more exposed surfaces of the second negative current collector.

9. The capacitor-assisted electrochemical cell of claim 1, wherein the carbonaceous material is selected from the group consisting of: activated carbon (AC), hard carbon (HC), soft carbon (SC), graphite, and combinations thereof, and
the metal oxide is selected from the group consisting of: titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂), and combinations thereof.

10. The capacitor-assisted electrochemical cell of claim 1, wherein the one or more positive electroactive material layers comprises a positive electroactive material selected from the group consisting of: LiCoO₂ (LCO), LiNiₓMn_{y}Co_{1-x-y}O₂ (where 0≤x≤1 and 0≤y≤1), LiNi_{1-x-y}CoₓAl_{y}O₂ (where 0≤x≤1 and 0≤y≤1), LiNiₓMn₁₋ₓO₂ (where 0≤x≤1), Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), and combinations thereof; and
the one or more first negative electroactive material layers comprises a first negative electroactive material selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

11. The capacitor-assisted electrochemical cell of claim 1, wherein each of the at least two first electrodes, the at least one second electrode, and the at least one composite electrode further comprises greater than or equal to about 0 wt. % to less than or equal to about 30 wt. % of one or more conductive additives selected from the group consisting of: carbon black, graphite, graphene, graphene oxide, acetylene black, carbon nanofibers, carbon nanotubes, and combinations thereof; and
greater than or equal to about 0 wt. % to less than or equal to about 20 wt. % of one or more binders selected from the group consisting of: poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof.

12. The capacitor-assisted electrochemical cell of claim 1, further comprising greater than or equal to about 1 wt. % to less than or equal to about 20 wt. % of an electrolyte, wherein the electrolyte is disposed between the at least two first electrodes, the at least one second electrode, and the at least one composite electrode, and a portion of the electrolyte is disposed within the plurality of pores in each negative electroactive particle in the at least one composite electrode.

13. A capacitor-assisted electrochemical cell comprising:
a positive electrode comprising a positive electroactive material layer; and
a composite electrode comprising a negative electroactive material layer that comprises a plurality of first negative electroactive particles and a plurality of second negative electroactive particles, wherein the second negative electroactive particles comprise one or more of a carbonaceous material and a metal oxide, and wherein each second negative electroactive particle of the plurality of second negative electroactive particles has a plurality of pores and a plurality of sulfur-additive particles embedded within the plurality of pores.

14. The capacitor-assisted electrochemical cell of claim 13, wherein the negative electroactive material layer is a first negative electroactive material layer and the capacitor-assisted electrochemical cell further comprises a negative electrode comprising a second negative electroactive material layer,
wherein the second negative electroactive material layer comprises one or more negative electroactive materials selected from the group consisting of: lithium metal, lithium alloy, silicon (Si), silicon alloy, silicon oxide activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

15. The capacitor-assisted electrochemical cell of claim 13, wherein the second negative electroactive particles have an average particle size greater than or equal to about 1 nm to less than or equal to about 1000 μm and a porosity greater than or equal to about 5 vol. % to less than or equal to about 80 vol. %, and
the plurality of sulfur-additive particles occupy greater than or equal to about 0.1 vol. % to less than or equal to about 100 vol. % of a total pore volume of each second negative electroactive particle.

16. The capacitor-assisted electrochemical cell of claim 13, wherein the pores have an average diameter of greater than or equal to about 0.1 nm to less than or equal to about 100 nm and the sulfur-additive particles have an average particle size of greater than or equal to about 0.1 nm to less than or equal to about 100 nm;
the composite electrode comprises greater than or equal to about 0.01 wt. % to less than or equal to about 99.99 wt. % of the first negative electroactive particles and greater than or equal to about 0.01 wt. % to less than or equal to about 99.99 wt. % of the second negative electroactive particles; and
the composite electrode further comprises greater than or equal to about 1 wt. % to less than or equal to about 20 wt. % of an electrolyte.

17. The capacitor-assisted electrochemical cell of claim 13, wherein the first negative electroactive particles include one or more first negative electroactive materials selected from the group consisting of: activated carbon (AC), hard carbon (HC), soft carbon (SC), silicon (Si), silicon oxide, tin (Sn), titanium dioxide (TiO₂), ferrous sulfide (FeS), lithium titanium oxide (LiTi₅O₁₂) (LTO), titanium niobium oxide (TiₓNb_{y}O_{z} where 0≤x≤2, 0≤y≤24, and 0≤z≤64), and combinations thereof; and
the second negative electroactive particles comprise one or more second negative electroactive materials selected from the group consisting of: activated carbon (AC), hard carbon (HC), soft carbon (SC), titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂), and combinations thereof.

18. An electroactive material that forms a portion of a capacitor comprising:
a plurality of negative electroactive particles comprising one or more of a carbonaceous material and a metal oxide, wherein each negative electroactive particles has a plurality of pores and wherein the carbonaceous material is selected from the group consisting of: activated carbon (AC), hard carbon (HC), soft carbon (SC), and combinations thereof and the metal oxide is selected from the group consisting of: titanium dioxide (TiO₂), iron (III) oxide (Fe₂O₃), iron (II) oxide (Fe₃O₄), iron (III) oxide-hydroxide (β-FeOOH), manganese oxide (MnO₂), niobium pentoxide (Nb₂O₅), ruthenium dioxide (RuO₂), and combinations thereof; and
a plurality of sulfur-additive particles disposed within the plurality of pores of the negative electroactive particles.

19. The electroactive material of claim 18, wherein the negative electroactive particles have an average particle size greater than or equal to about 1 nm to less than or equal to about 1000 μm and a porosity greater than or equal to about 5 vol. % to less than or equal to about 80 vol. %; and
the sulfur-additive particles occupy greater than or equal to about 0.01 vol. % to less than or equal to about 99.99 vol. % of a total pore volume of each negative electroactive particle.

20. The electroactive material of claim 18, wherein the plurality of pores have an average diameter greater than or equal to about 0.1 nm to less than or equal to about 100 nm and the sulfur-additive particles have an average particle size greater than or equal to about 0.1 nm to less than or equal to about 100 nm.
